(19) United States
(12) Patent Application Publication
(10) Pub. No.: US 2018/0045651 A1
(43) Pub. Date: Feb. 15, 2018

(54) RAMAN SPECTROMETER

(71) Applicant: China Jiliang University, Hangzhou Zhejiang (CN)

(72) Inventors: Huaizhou Jin, Hangzhou Zhejiang (CN); Kaiyuan Liu, Hangzhou Zhejiang (CN); Shangzhong Jin, Hangzhou Zhejiang (CN); Lingling Chen, Hangzhou Zhejiang (CN); Wenhuai Li, Hangzhou Zhejiang (CN); Kun Yuan, Hangzhou Zhejiang (CN)

(21) Appl. No.: 15/298,561

(22) Filed: Oct. 20, 2016

(30) Foreign Application Priority Data
Aug. 15, 2016 (CN) 201610670153.6

(51) Int. Cl. G01N 21/87; G01J 3/26; G01N 21/65; G01J 3/44

(52) U.S. Cl. CPC G01N 21/87; G01J 3/44; G01J 3/26; G01N 21/65; G01N 2201/06113

(57) ABSTRACT

A Raman spectrometer includes a laser, a lens, a dichroscope, a confocal microscope, an optical system, a Fabri-Perot tunable filter and a silicon detector. The light emitted by the laser impinges on the dichroscope after passing through the lens. The dichroscope reflects the light, and the reflected light impinges on a sample through the confocal microscope. The light generates a Rayleigh scattering and a Raman scattering upon reaching the sample, scattered light generating the Rayleigh scattering and the scattered light generating the Raman scattering impinge on the dichroscope again after passing through the confocal microscope. The Raman scattered light transmitted by the dichroscope passes through the optical system and the Fabri-Perot tunable filter successively, and the light passing through the Fabri-Perot tunable filter is detected by the silicon detector to obtain a light signal. The Raman spectrometer has the advantages of small volume and low cost.

### CROSS-REFERENCE TO RELATED APPLICATION

This application claims priority to Chinese Application No. 201610670153.6, which was filed Aug. 15, 2016. This prior application is incorporated herein by reference, in its entirety.

### TECHNICAL FIELD

The present invention relates to a field of gem identification, and in particular, to a Raman spectrometer.

### BACKGROUND

With the expansion of the jewelry market, more and more artificial gems and fake gems appear on the market, and these jewels are deceptive and shoddy. Traditional gem identification mainly relies on the experience of appraisers by means of magnifiers, areometers, microscopes, refractometers and the like. However, with the development of high and new technology, the synthesis method of the artificial gems and the method of optimizing treatment of the gems are promoted as well. Some synthetic gems have the same chemical compositions, crystal structures and physical properties as the natural gems, and the traditional identification technology cannot meet the gem identification requirements anymore.

The spectrum detection technology has advantages of being nondestructive, rapid and highly accurate, has gained extensive attention and development in the research of the gems, and is a relatively authoritative analysis manner of gem identification at present. Raman spectrum analysis technology is widely used in the substance identification and in the research of molecular structures. However, a high-precision grating light splitting system is used in a general Raman spectrometer, which has a high price and a large volume, so that the wide application of the Raman spectrum detection technology in the gem identification is limited.

### SUMMARY

The object of the present invention is to provide a portable Raman spectrometer, which is small in volume and low in price.

To achieve the above object, the present invention provides the following solution:

A Raman spectrometer comprises a laser, a lens, a dichroscope, a confocal microscope, an optical system, a Fabri-Perot tunable filter and a silicon detector, wherein, the light emitted by the laser impinges on the dichroscope after passing through the lens, the dichroscope reflects the light, the reflected light impinges on a sample through the confocal microscope, the light generates a Rayleigh scattering and a Raman scattering upon reaching the sample, scattered light generating the Rayleigh scattering and the scattered light generating the Raman scattering impinge on the dichroscope again after passing through the confocal microscope, the dichroscope transmits the Raman scattered light in the scattered light and reflects the Rayleigh scattered light, the Raman scattered light transmitted by the dichroscope passes through the optical system and the Fabri-Perot tunable filter successively, and the light passing through the Fabri-Perot tunable filter is detected by the silicon detector to obtain a light signal.

Optionally, the Raman spectrometer further comprises an amplifier, an A/D converter and a software system, wherein the software system comprises a parameter optimization module and a data processing module, and the light signal detected by the silicon detector is optimized by the parameter optimization module and the data processing module after being amplified by the amplifier and converted by the A/D converter.

Optionally, the software system further comprises a database matching identification module and a database adding module, the database matching identification module is used for matching Raman spectrum data of the sample with the Raman spectrum data of natural gems, artificial gems and fake gems in the database, and the database adding module is used for adding the Raman spectrum data of the natural gems, the artificial gems or the fake gems into the database.

Optionally, the optical system consists of two lenses and is used for converging the Raman scattered light.

Optionally, the Fabri-Perot tunable filter is used for splitting the light.

Optionally, the Fabri-Perot tunable filter is manufactured by the micro-electromechanical processing technology.

Optionally, the laser is a semiconductor laser, the wavelength of laser emitted by the laser is 532-785 nm, the power of the laser is 50-100 mW, the bandwidth of the laser is less than 0.01 nm, and the spot diameter of the laser is less than 3 μm.

According to the embodiments provided by the present invention, the present invention discloses the following technical effects: the dichroscope in the Raman spectrometer provided by the present invention has both functions of reflecting the light to the confocal microscope and filtering the light scattered by the sample; the one element plays the functions of two elements, thereby reducing the number of the elements and the volume of the spectrometer; moreover, the Fabri-Perot tunable filter having a small volume is used for splitting the light in the present invention; and the optical system consisting of two lenses is used for converging the scattered light, so the volume of the spectrometer is further reduced.

### BRIEF DESCRIPTION OF THE DRAWINGS

To illustrate technical solutions in the embodiments of the present invention or in the prior art more clearly, a brief introduction on the accompanying drawings for use in the embodiments is given below. Apparently, the accompanying drawings in the description below are merely some of the embodiments of the present invention, based on which other drawings can also be obtained by the person skilled in the art without any creative effort.

FIG. 1 is a schematic diagram of the structure of a Raman spectrometer in an embodiment of the present invention;

FIG. 2 is a schematic diagram of the structure of an optical system of a Raman spectrometer in an embodiment of the present invention.

### DETAILED DESCRIPTION

A clear and complete description of technical solutions in the embodiments of the present invention will be given below, in combination with the accompanying drawings in the embodiments of the present invention. Apparently, the embodiments described are merely a part, but not all, of the embodiments of the present invention. All of other embodiments, obtained by the person skilled in the art based on the embodiments of the present invention without any creative effort, should fall into the protection scope of the present invention.

The object of the present invention is to provide a portable Raman spectrometer, which is small in volume and low in price.

In order that the above object, the features and the advantages of the present invention are more apparent and understandable, a further detailed description of the present invention will be given below in combination with the accompanying drawings and the embodiments.

The Raman spectrum detection technology is based on the inelastic scattering of light. When the laser is incident on a substance, the laser generates a Stokes inelastic scattering, namely Raman shift. Each kind of substance has its own specific Raman shift, including the number of the Raman spectral line, the displacement size and the spectral line intensity, and the Raman shift is directly related to the molecular vibration or the rotational energy level of a test sample and is called “fingerprint” of the substance. Therefore the composition and the crystal structure of the test sample can be characterized to obtain substance information, so as to achieve the objects of measurement and identification.

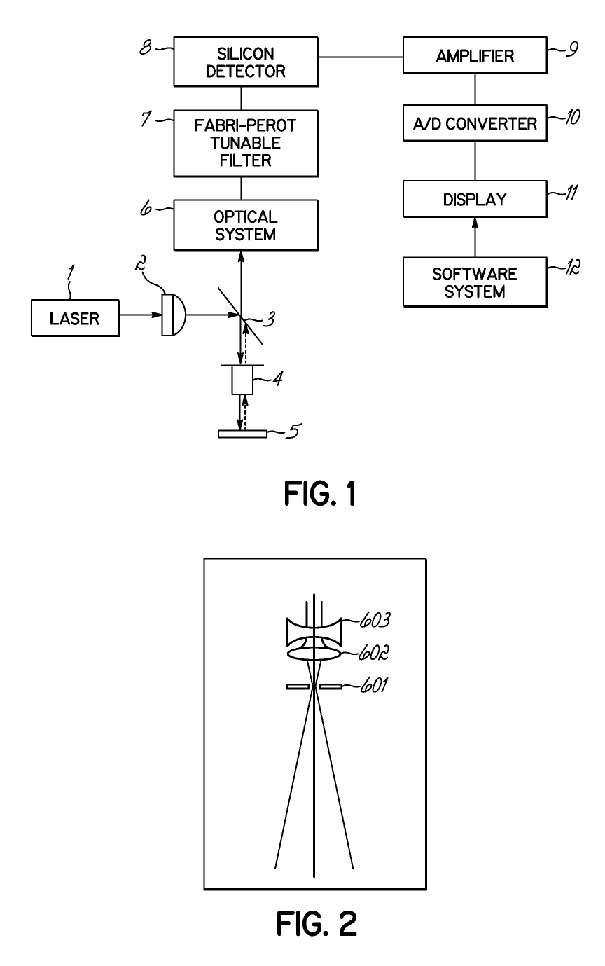

FIG. 1 is a schematic diagram of the structure of a Raman spectrometer in an embodiment of the present invention. As shown in FIG. 1, at first, the light emitted by a laser 1 is reflected by a dichroscope 3 after passing through a light path formed by a lens 2 and the dichroscope 3 and then is emitted from a confocal microscope 4 to impinge on a sample 5. The light generates a Rayleigh scattering and a Raman scattering upon reaching the sample. The scattered light is converged by the confocal microscope. The dichroscope transmits the Raman scattered light, reflects the Rayleigh scattered light, and therefore the Rayleigh scattered light in the signal is filtered and thus the signal-to-noise ratio is improved. Then, the Raman signal is vertically incident into a Fabri-Perot tunable optical filter 7 through an optical system 6 to undergo light splitting. The light signal is detected by a silicon detector 8. Finally, the signal is processed by an amplifier 9 and an A/D converter 10, and then a Raman spectrum of the detected sample is obtained on a display 11. The detection process, subsequent data processing and database matching and the like are all controlled by a software system 12.

The laser in the present invention is used for emitting a laser source, and the wavelength of the emitted laser is 532-785 nm. The dichroscope is used for changing the direction of the laser source and also enabling all Raman scattered light of the sample to pass through, as well as reflecting the Rayleigh scattered light, laser stray light and the like mixed therein and thus preventing them passing through to achieve the effect of filtering them and therefore to improve the signal-to-noise ratio. The confocal microscope is used for collecting scattered light signals. The optical system is used for converging the Raman scattered light. FIG. 2 is a schematic diagram of the structure of an optical system of a Raman spectrometer in an embodiment of the present invention. As shown in FIG. 2, the optical system consists of a pinhole diaphragm and a collimating lens. The pinhole diaphragm 601 is confocal with a sampling point on the sample via the confocal microscope 4. The pinhole diaphragm 601 is used for improving the position accuracy and measuring the signal-to-noise ratio. The collimating lens is used for collimating the Raman signal light emitted from the microscope into parallel light. The collimating lens consists of a convex lens 602 and a concave lens 603. The convex lens 602 is used for converging the light passing through the pinhole diaphragm 601, and the convex lens 602 can converge most of the light passing through the pinhole diaphragm 601. The concave lens 603 is used for converting the light converged by the convex lens 602 into the parallel light which is incident on the Fabri-Perot tunable optical filter so as to achieve monochromatic light signal detection of the split lights. The Fabri-Perot tunable optical filter is mainly based on the Fabri-Perot interferometer principle and mainly consists of two parallel glass plates. There exists a certain gap between the two parallel glass plates and opposite inner surfaces of the two parallel glass plates have high reflectivity, thus an interference cavity is formed. The Raman signal light is vertically incident on the parallel glass plates after passing through the optical system. A layer of thin film structure is provided on the upper glass plate. When the gap is mλ/2 (m is an integer), the upper glass plate is equivalent to a light filter, which only allows the light at a wavelength of λ to pass through. A voltage may be applied to the parallel glass plates, and the gap between the two parallel glass plates can be adjusted by controlling the magnitude of the voltage. As the gap is changed, the wavelength of the transmitted light is changed as well, and thus light splitting is achieved. The silicon detector is used for detecting the Raman light signal after passing through the Fabri-Perot tunable optical filter and has better cost efficiency. The amplifier is used for amplifying the detected signal. The A/D converter is used for converting an analog signal into a digital signal for processing. The display is an interface for various operations and can display the Raman spectrum. In addition to such functions as parameter optimization, data processing and the like, the software system further includes functions of database matching identification, database adding and the like. Raman spectrum data of common natural gems, artificial gems and fake gems is stored in the database. Based on some characteristic Raman peaks of the common natural gems, the artificial gems and the fake gems, the authenticity and the quality, for example, presence of dye filling, of the gems can be identified.

The types of gems capable of being identified by the Raman spectrometer provided by the present invention include ruby, sapphire, emerald, diamond, jade and the like. The ruby has 7 characteristic Raman shift peaks, which are respectively in the vicinity of 378 cm⁻¹, 417 cm⁻¹, 430 cm⁻¹, 447 cm⁻¹, 576 cm⁻¹, 645 cm⁻¹ and 750 cm⁻¹. The sapphire has the same main components and the same characteristic peaks as the ruby, and the difference from the ruby lies in that the ruby contains the element chromium, but the sapphire contains titanium and iron and other elements, and thus a result can be obtained in combination with color identification. The major Raman peaks of the emerald are in the vicinity of 684 cm⁻¹ and 412 cm⁻¹. The characteristic Raman shift of the diamond is 1332 cm⁻¹, and the major Raman shift peaks of the jade are in the vicinity of 378 cm⁻¹, 702 cm⁻¹ and 1040 cm⁻¹.

In accordance with the positions of the detected Raman shift peaks, the type of the gem can be determined. If the major Raman peaks appear in the vicinity of 378 cm⁻¹, 702 cm⁻¹ and 1040 cm⁻¹, the gem can be determined as the emerald. Based on the peak intensity, the half-width and other information of the Raman peaks, it can be determined whether a crystal structure on the surface of the gem is damaged. If the detected characteristic peak intensity becomes relatively small and the half-width of the peak is widened, it indicates that the crystal on the surface of the gem is damaged and the gem is rinsed and bleached by a strong acid. The substance type, for example, filling material, organic dye and the like, contained in the gem can be determined by the fluorescent information of the Raman spectrum and the specific positions of other Raman peaks appearing in the spectrum. If a larger fluorescence inclusion and some other Raman peaks of, for example, 1162 cm⁻¹ and 1123 cm⁻¹ (which are characteristic Raman shifts of epoxy resin benzene ring) and the like appear in the Raman spectrum, it can be determined that the gem is subjected to a dye treatment with the organic dye and a filling treatment with the epoxy resin.

The dichroscope in the Raman spectrometer provided by the present invention has both functions of reflecting the laser rays to the confocal microscope and filtering the Rayleigh scattered light of the sample. The one element plays the functions of two elements, thereby reducing the number of the elements and reducing the volume of the spectrometer. Moreover, the Fabri-Perot tunable optical filter having a small volume is used for splitting the light in the present invention, and the optical system consisting of two lenses is used for converging the scattered light, so the volume of the spectrometer is further reduced, and accordingly, the Raman spectrometer provided by the present invention has the advantages of being small in volume and portable.

Specific examples are used herein to illustrate the principles and the implementations of the present invention, and the illustration of the above embodiments is merely used for helping to understand the method of the present invention and the core idea thereof; and meanwhile, to the person skilled in the art, variations can be made to the embodiments and the application range according to the idea of the present invention. In summary, the contents in the description should not be construed as limiting the present invention.

What is claimed is:

1. A Raman spectrometer, comprising:
a laser,
a lens,
a dichroscope,
a confocal microscope,
an optical system,
a Fabri-Perot tunable filter, and
a silicon detector,
wherein, the light emitted by the laser impinges on the dichroscope after passing through the lens, the dichroscope reflects the light, the reflected light impinges on a sample through the confocal microscope, the light generates a Rayleigh scattering and a Raman scattering upon reaching the sample, scattered light generating the Rayleigh scattering and the scattered light generating the Raman scattering impinge on the dichroscope again after passing through the confocal microscope, the dichroscope transmits the Raman scattered light in the scattered light and reflects the Rayleigh scattered light, the Raman scattered light transmitted by the dichroscope passes through the optical system and the Fabri-Perot tunable filter successively, and the light passing through the Fabri-Perot tunable filter is detected by the silicon detector to obtain a light signal.

2. The Raman spectrometer of claim 1, further comprising:
an amplifier, an A/D converter, and a software system,
wherein the software system comprises a parameter optimization module and a data processing module, and the light signal detected by the silicon detector is optimized by the parameter optimization module and the data processing module after being amplified by the amplifier and converted by the A/D converter.

3. The Raman spectrometer of claim 2, wherein the software system further comprises:
a database matching identification module and a database adding module, the database matching identification module is used for matching Raman spectrum data of the sample with the Raman spectrum data of natural gems, artificial gems and fake gems in the database, and the database adding module is used for adding the Raman spectrum data of the natural gems, the artificial gems or the fake gems into the database.

4. The Raman spectrometer of claim 1, wherein the optical system consists of:
a pinhole diaphragm and a collimating lens, wherein the pinhole diaphragm is confocal with a sampling point on the sample via the confocal microscope and is used for improving the position accuracy and measuring a signal-to-noise ratio, and the collimating lens consisting of two lenses is used for collimating the Raman signal light emitted from the microscope into parallel light which is incident on the Fabri-Perot tunable filter so as to achieve the detection of the split lights.

5. The Raman spectrometer of claim 1, wherein the Fabri-Perot tunable filter is used for splitting the light.

6. The Raman spectrometer of claim 1, wherein the Fabri-Perot tunable filter is manufactured using micro-electromechanical processing technology.

7. The Raman spectrometer of claim 5, wherein the laser is a semiconductor laser, a wavelength of laser emitted by the laser is 532-785 nm, a power of the laser is 50-100 mW, a bandwidth of the laser is less than 0.01 nm, and a spot diameter of the laser is less than 3 μm.
